(19) United States
(12) Patent Application Publication
(10) Pub. No.: US 2004/0073817 A1
(43) Pub. Date: Apr. 15, 2004

(54) Method for automatically saving in-process programs before shutdown

(76) Inventors: Chia-Yuan Liu, Tu-Chen (TW); Hong-Chieh Kao, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/335,508

(22) Filed: Dec. 30, 2002

(30) Foreign Application Priority Data
Oct. 9, 2002 (TW) 91123249

(51) Int. Cl. G06F 1/26

(52) U.S. Cl. 713/300

(57) ABSTRACT

A method for automatically saving programs processed in electrically powered devices when a shutdown event occurs. The method is implemented in a power supply system including a plurality of primary UPSs (10) and a monitoring device (4). The monitoring device monitors the primary UPSs and electrically powered devices (3), and sends a shutdown instruction having a time delay when a shutdown event occurs. When the electrically powered devices receive the shutdown instruction, they automatically check whether there are programs being processed therein. If there are such in-process programs, the electrically powered devices automatically save the in-process programs according to pop-out dialog boxes that provide saving prompts. After all the in-process programs are saved and shut down, the primary UPSs and the electrically powered devices are automatically shut down.

### BACKGROUND OF THE INVENTION

1. Field of the Invention

This invention relates to methods for automatically saving in-process files and programs when a shutdown occurs, and more particularly to methods which automatically monitor electrically powered devices and a power supply and which save programs processed in the electrically powered devices when a shutdown event occurs.

2. Description of Related Art

In recent years, information technology and web technology have advanced rapidly. The convenience of electronic data interchange and data storage has enabled enterprises to transmit and store important information using personal computers, notebooks, servers and like devices. Security and protection of data has become increasingly important. One problem related to data security is power supply for the above-mentioned devices. A sudden voltage sag or an unforeseen power failure can lead to an abnormal shutdown of electrically powered devices, in which unsaved files and programs may be damaged or lost. Most computer equipment requires a stable and uninterrupted power supply whose voltage is kept within a range from −13% to +6% of a standard voltage. If the voltage falls out of this range, the computer equipment cannot operate properly or may even become unusable.

An uninterrupted power supply (UPS) can provide stable and continuous electrical power. Many important items of computer equipment, such as servers, use online UPSs to ensure a secure power supply. An online UPS is directly connected with an external electrical source. However, if one or more online UPSs are inoperative because of malfunction, the electrically powered devices connected to the online UPSs may be shut down due to insufficient power supply. In that event, an operator must manually run standby UPSs to replace the inoperative UPSs. If there are many items of computer equipment powered by a set of UPSs, it is difficult for the operator to manually monitor the set of UPSs and run standby UPSs in time.

In addition, electrical power stored in a UPS is limited, and can only support a computer's operation for a short time. If a power supply from an external power source is lost, files and programs being processed in the computer need to be saved and shut down in short time.

China Pat. Appl. No. CN1360382A discloses an apparatus and method for securely shutting down computer equipment and UPSs when an abnormal event occurs. However, the apparatus cannot automatically invoke standby UPSs when primary UPSs are inoperative in order to save in-process files before shutdown.

Accordingly, what is needed is a system and method which can overcome the abovementioned problems.

### SUMMARY OF THE INVENTION

A primary object of the present invention is to provide a method which automatically monitors electrically powered devices and a power supply, and which saves programs processed in the electrically powered devices when a shutdown event occurs.

Another object of the present invention is to provide a method for an electrically powered device to automatically save in-process programs when receiving a shutdown instruction.

In one aspect of the present invention, a method for automatically saving in-process programs in a shutdown is provided. The method is implemented in a power supply system including a plurality of primary UPSs and a monitoring device. A preferred embodiment of the method comprises the steps of: monitoring the primary UPSs and electrically powered devices connected to the primary UPSs; determining whether there is a shutdown event; sending out a shutdown instruction having a preset time delay when there is a shutdown event; determining whether there are programs in process in each of the electrically powered devices; saving and shutting down the in-process programs when there are programs in process; and shutting down the electrically powered devices.

In another aspect of the present invention, a method for an electrically powered device to automatically save in-process programs in a shutdown is provided. A preferred embodiment of the method comprises the steps of: receiving a shutdown instruction; determining whether there are any programs in process; selecting an in-process program when there are programs in process; sending a shutdown message to the in-process program; determining whether there is a pop-out dialog box; determining whether the pop-out dialog box is a saving prompt when there is a pop-out dialog box; saving the in-process program and closing the pop-out dialog box when the pop-out dialog box is a saving prompt; and shutting down the in-process program.

Other objects, advantages and novel features of the present invention will be drawn from the following detailed description of preferred embodiments of the present invention with attached drawings, in which:

### BRIEF DESCRIPTION OF THE DRAWINGS

FIG. 1 is a schematic diagram of basic hardware infrastructure of a preferred embodiment of a system of the present invention for automatically saving in-process programs when a shutdown occurs;

FIG. 2 is a block diagram of infrastructure of a primary UPS of the system of FIG. 1;

FIG. 3 is a schematic diagram showing main function modules of a monitoring device of the system of FIG. 1;

FIG. 4 is a flowchart of a preferred method of the present invention for automatically saving in-process programs when a shutdown occurs, the method being implemented in the system of FIG. 1;

FIG. 5 is a detailed flowchart of saving and shutting down in-process programs, according to one step of FIG. 4;

FIG. 6 is a schematic diagram of basic hardware infrastructure of an alternative embodiment of the system of the present invention for automatically saving in-process programs when a shutdown occurs; and

FIG. 7 is a flowchart of an alternative method for automatically saving in-process programs when a shutdown occurs, the method being implemented in the system of FIG. 6.

### DETAILED DESCRIPTION OF THE INVENTION

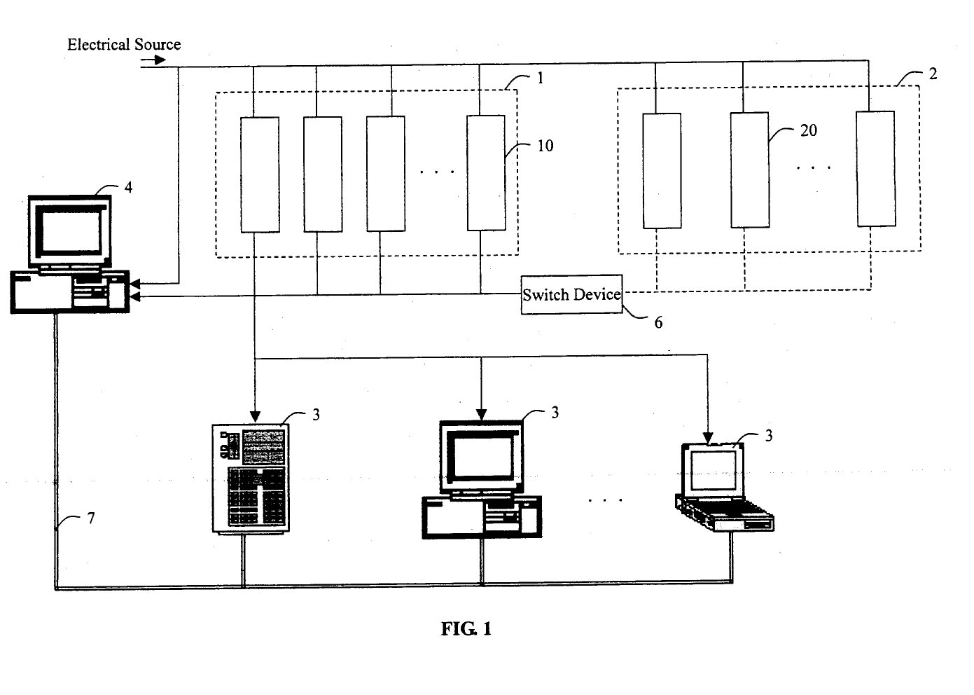

FIG. 1 is a schematic diagram of basic hardware infrastructure of a preferred embodiment of a system of the present invention for automatically saving in-process programs when a shutdown occurs. The system comprises a primary Uninterrupted Power Supply (UPS) set 1, a standby UPS set 2, a monitoring device 4, a switch device 6, and a plurality of electrically powered devices 3. The primary UPS set 1 comprises a plurality of primary UPSs 10 for providing electrical power to the electrically powered devices 3. The primary UPS set 1 is connected to an external electrical source for a continuous power supply. Electrical power from the external electrical source is regulated by the primary UPSs 10 before being provided to run the electrically powered devices 3. In the preferred embodiment of the present invention, all the primary UPSs 10 are online UPSs that directly connect with the external electrical source.

The standby UPS set 2 comprises a plurality of standby UPSs 20 for providing power to the electrically powered devices 3 when there are malfunctions on the primary UPSs 10. The standby UPSs 20 are switched from a “standby” state to a “working” state when one or more primary UPSs 10 are unusable because of malfunction. These “standby” and “working” states are hereinafter referred to as the operational states of the standby UPSs 20.

The switch device 6 is for switching the standby UPSs 20 between the standby and working states.

The monitoring device 4 can be a personal computer that has monitoring software installed therein for monitoring malfunctions occurring on the system. The monitoring device 4 can interchange data with the primary UPS set 1 and the standby UPS set 2 via Serial Bus or network connections. The monitoring device 4 receives data from or sends data to the electrically powered devices 3 via an intranet 7.

The electrically powered devices 3 can be personal computers, servers, notebooks, workstations and other devices that require a stable and continuous power supply.

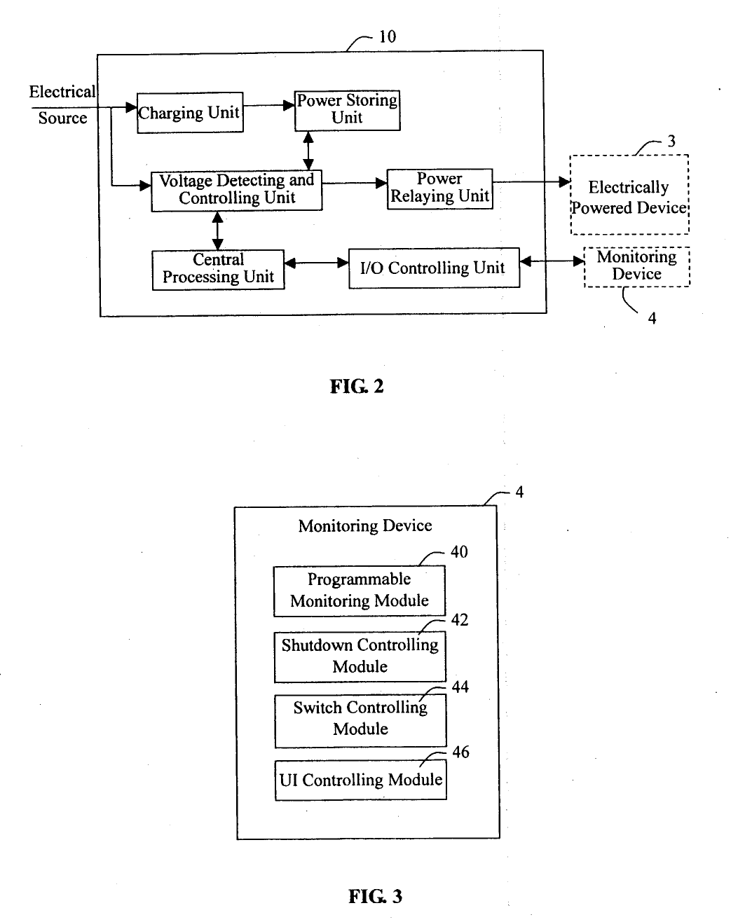

FIG. 2 is a block diagram of infrastructure of any one primary UPS 10. The primary UPS 10 comprises a charging unit, a power storing unit, a voltage detecting and controlling unit, a power relaying unit, a central processing unit, and an Input/Output (I/O) controlling unit. The charging unit is connected to the external electrical source for charging up the primary UPS 10. The power storing unit is for storing electrical power in the primary UPS 10. The voltage detecting and controlling unit connects to the external electrical source for detecting voltage provided by the external electrical source. A message regarding voltage detected by the voltage detecting and controlling unit is sent to the central processing unit, which then sends instructions to the voltage detecting and controlling unit and the power relaying unit according to the voltage detected. If the voltage is too low to run the electrically powered devices 3, the central processing unit instructs the voltage detecting and controlling unit to obtain electrical power stored in the power storing unit, and instructs the power relaying unit to relay power to the electrically powered devices 3. The I/O controlling unit is for data interchange with the monitoring device 4.

FIG. 3 is a schematic diagram showing main function modules of the monitoring device 4. The monitoring device 4 comprises a programmable monitoring module 40, a shutdown controlling module 42, a switch controlling module 44, and a user interface (UI) controlling module 46. The programmable monitoring module 40 is for monitoring a power supply of the external electrical source, and monitoring operational states of the primary UPSs 10. The operational states are “standby” and “working,” just as for the standby UPSs 20. The programmable monitoring module 40 obtains power supply data from the central processing units via the I/O controlling units of the primary UPSs 10. Normally, the programmable monitoring module 40 sends a query message to each primary UPS 10 at preset regular time intervals, and then determines whether all the primary UPSs 10 are in a normal state according to feedback messages sent by the primary UPSs 10 in response to the respective query messages.

The shutdown controlling module 42 is for sending shutdown instructions to the primary UPSs 10, the standby UPSs 20 and the electrically powered devices 3. When an abnormal event occurs, the shutdown controlling module 42 sends out a shutdown instruction having a preset time delay. An abnormal event may be loss of the external power supply, or malfunction of the primary UPSs 10. The preset time delay is input by system administrators, and provides the electrically powered devices 3 time to save in-process programs before the shutdown instruction is implemented.

The switch controlling module 44 is for controlling the switch device 6 to switch operational states of the standby UPSs 20. When the programmable monitoring module 40 detects that one or more primary UPSs 10 are unusable due to malfunction, the switch controlling module 44 automatically instructs the switch device 6 to invoke the standby UPSs 20 for a continuous power supply. The number of standby UPSs 20 invoked is equal to the number of primary UPSs 10 that are unusable. In addition, system administrators can manually invoke the standby UPSs 20 via the switch controlling module 44.

The UI controlling module 46 is provided for system administrators to search for current statuses of the power supply, the UPSs 10, 20 and the electrically powered devices 3, and to set relevant parameters and give instructions.

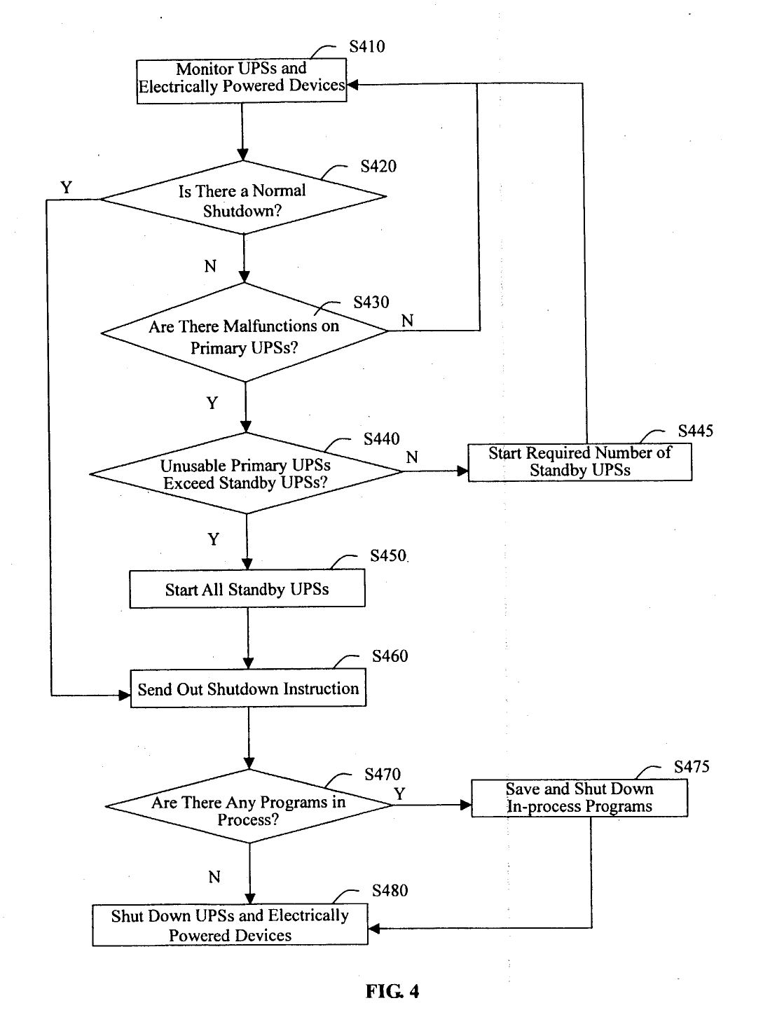

FIG. 4 is a flowchart of a preferred method of the present invention for automatically saving in-process programs when a shutdown occurs, the method being implemented in the above-described preferred embodiment of the system of the present invention. In step S410, the monitoring device 4 automatically monitors operational states of the main hardware units, including the primary UPS set 1, the standby UPS set 2 and the electrically powered devices 3. The monitoring device 4 periodically sends a query message to each said hardware unit, and obtains information on an operational state thereof according to a feedback message sent by the hardware unit. In step S420, the monitoring device 4 determines whether there is a normal shutdown instruction. The normal shutdown instruction is generally given by a system administrator, for shutting down one or more primary UPSs 10 or electrically powered devices 3. If there is a normal shutdown instruction, the procedure proceeds directly to step S460 described below. If there is no normal shutdown instruction, in step S430, the monitoring device 4 determines whether there are malfunctions on the primary UPSs 10. The monitoring device 4 periodically sends a query message to each primary UPS 10, and obtains operational states of the primary UPSs 10 according to feedback messages sent by the primary UPSs 10. If all the primary UPSs 10 are in a normal state, the procedure returns to step S410. If one or more primary UPSs 10 are unusable because of malfunction, in step S440, the monitoring device 4 counts the number of unusable primary UPSs 10, and determines whether the number of unusable primary UPSs 10 exceeds a total number of standby UPSs 20. If the number of unusable primary UPSs 10 does not exceed the total number of standby UPSs 20, in step S445, the monitoring device 4 automatically starts as many of the standby UPSs 20 as are needed for a continuous power supply, and the procedure returns to step S410.

If the number of unusable primary UPSs 10 exceeds the total number of standby UPSs 20, in step S450, the monitoring device 4 automatically starts all standby UPSs 20. In step S460, the monitoring device 4 sends out a shutdown instruction having a preset time delay to the electrically powered devices 3, the primary UPSs 10 and the standby UPSs 20. Before the shutdown instruction is implemented, in step S470, the electrically powered devices 3 check whether there are programs being processed therein. If there are no programs being processed in the electrically powered devices 3, in step S480, the primary and standby UPSs 10, 20 and the electrically powered devices 3 are shut down. If there are programs being processed in the electrically powered devices 3, in step S475, the in-process programs are saved and shut down, whereupon the procedure proceeds to step S480.

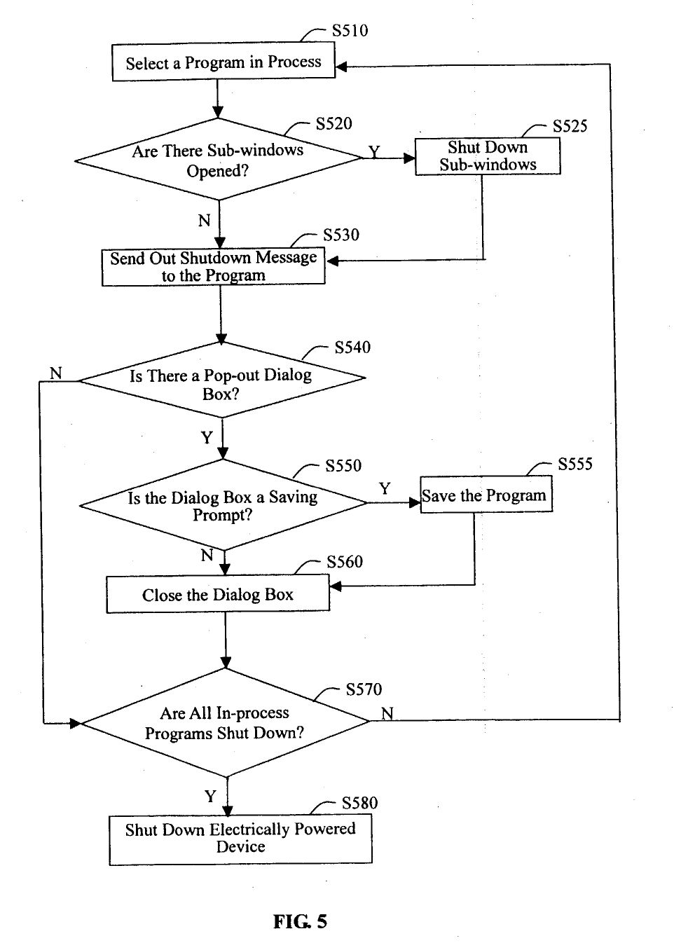

FIG. 5 is a detailed flowchart of saving and shutting down in-process programs, according to step S475 in FIG. 4. After receiving the shutdown instruction sent by the monitoring device 4, in step S510, each electrically powered device 3 first selects a program that is in process. In step S520, the electrically powered device 3 determines whether the program has sub-windows opened. If the program has no opened sub-windows, in step S530, the electrically powered device 3 sends out a shutdown message to the program. If the program has opened sub-windows, in step S525, the electrically powered device 3 shuts down the sub-windows, and thereupon in step S530 the electrically powered device 3 sends out a shutdown message to the program. In step S540, the electrically powered device 3 determines whether there is a pop-out dialog box when shutting down the program. If there is no pop-out dialog box, the procedure proceeds directly to step S570 described below. If there is a pop-out dialog box, in step S550, the electrically powered device 3 determines whether the pop-out dialog box is a saving prompt. If the pop-out dialog box is a saving prompt, in step S555, the electrically powered device 3 saves the program, whereupon in step 560 the electrically powered device 3 closes the pop-out dialog box. If the pop-out dialog box is not a saving prompt, in step S560, the electrically powered device 3 directly closes the pop-out dialog box. In step S570, the electrically powered device 3 checks whether all in-process programs are shut down. If there are programs still in process, the procedure returns to step S510. If all in-process programs are shut down, in step S580, the electrically powered device 3 is shut down.

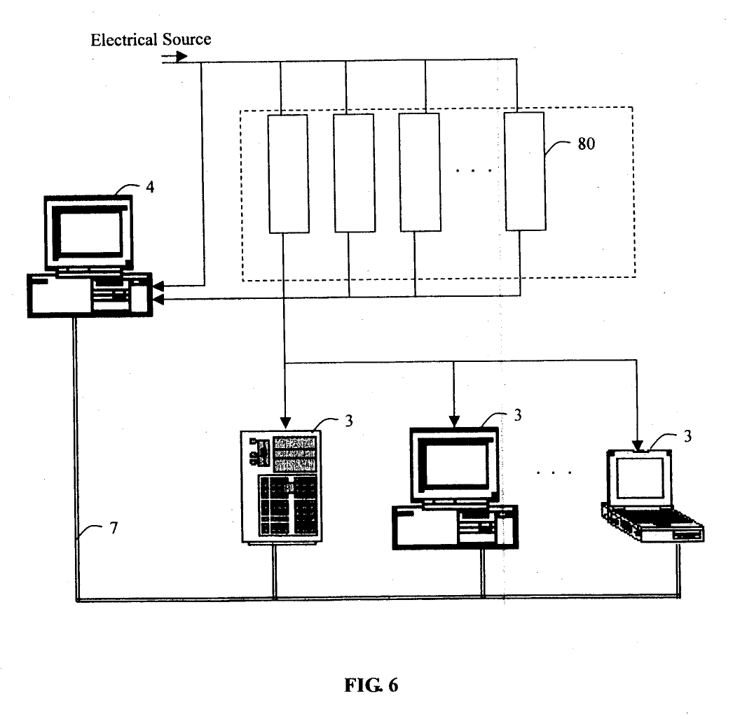

FIG. 6 is a schematic diagram of basic hardware infrastructure of an alternative embodiment of the system of the present invention for automatically saving in-process programs when a shutdown occurs. In the alternative embodiment, no standby UPS set is provided. Electrical power is supplied only by a plurality of primary UPSs 80. Other devices shown in FIG. 6 are similar to the devices of the preferred embodiment of the present invention shown in FIG. 1.

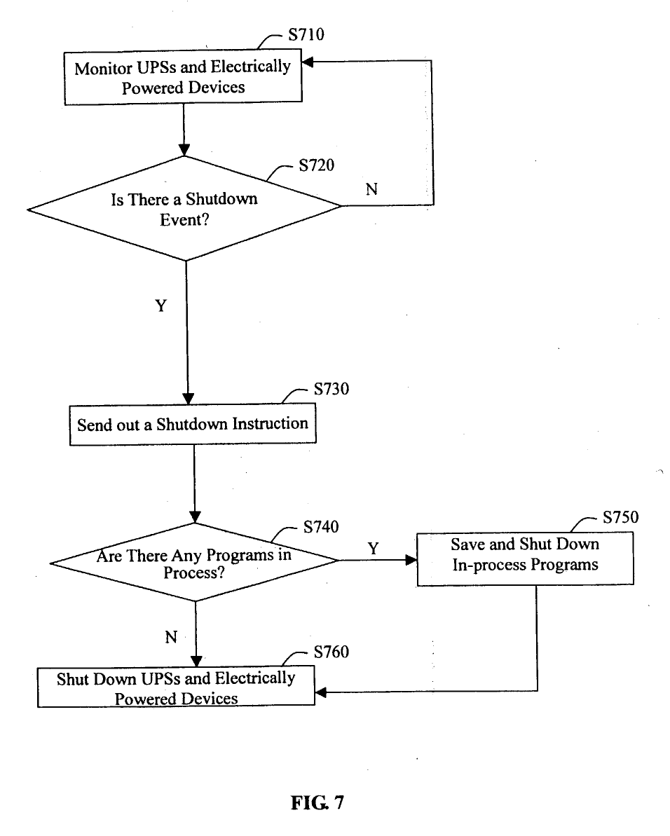

FIG. 7 is a flowchart of an alternative method for automatically saving in-process programs when a shutdown occurs, the method being implemented in the above-described alternative embodiment of the system of the present invention. In step S710, the monitoring device 4 automatically monitors operational states of the main hardware units, including the primary UPSs 80 and the electrically powered devices 3. In step S720, the monitoring device 4 determines whether there is a shutdown event. The shutdown event may be normal shutdown or abnormal shutdown. If there is no shutdown event, the procedure returns to step S710. If there is a shutdown event, in step S730, the monitoring device 4 sends out a shutdown instruction having a preset time delay to the electrically powered devices 3. Before the shutdown instruction is implemented, in step S740, the electrically powered devices 3 check whether there are programs being processed therein. If there are no programs being processed in the electrically powered devices 3, in step S760, the electrically powered devices 3 are shut down. If there are programs being processed in the electrically powered devices 3, in step S750, the in-process programs are saved and shut down. Then in step S760, the electrically powered devices 3 are shut down.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A method for automatically saving in-process programs in a shutdown, the method being implemented in a power supply system including a plurality of primary UPSs and a monitoring device, the method comprising the steps of:
monitoring the primary UPSs and electrically powered devices connected to the primary UPSs;
determining whether there is a shutdown event;
sending out a shutdown instruction having a preset time delay when there is a shutdown event;
determining whether there is any program in process in each of the electrically powered devices;
saving and shutting down all in-process programs when there is any program in process; and
shutting down the electrically powered devices.

2. The method as claimed in claim 1, wherein the step of saving and shutting down all in-process programs comprises the steps of:
selecting an in-process program;
sending a shutdown message to the in-process program;
determining whether there is a pop-out dialog box;
determining whether the pop-out dialog box is a saving prompt when there is a pop-out dialog box;
saving the in-process program and closing the pop-out dialog when the pop-out dialog box is a saving prompt; and
shutting down the in-process program.

3. The method as claimed in claim 2, further comprising the steps of:
determining whether there is any opened sub-window; and
shutting down all opened sub-windows when there is any opened sub-window.

4. The method as claimed in claim 2, further comprising the step of:
shutting down the in-process program when there is no pop-out dialog box.

5. The method as claimed in claim 2, further comprising the step of:
closing the pop-out dialog box when the pop-out dialog box is not a saving prompt.

6. The method as claimed in claim 1, wherein the shutdown event comprises either or both of normal shutdown and abnormal shutdown.

7. The method as claimed in claim 1, wherein the preset time delay is input by an administrator, and provides the electrically powered devices time to save any in-process program before the shutdown instruction is implemented.

8. A method for an electrically powered device to automatically save an in-process program in a shutdown, the method comprising the steps of:
receiving a shutdown instruction;
determining whether there is any program in process;
selecting an in-process program when there is any program in process;
sending a shutdown message to the in-process program;
determining whether there is a pop-out dialog box;
determining whether the pop-out dialog box is a saving prompt when there is a pop-out dialog box;
saving the in-process program and closing the pop-out dialog box when the pop-out dialog box is a saving prompt; and
shutting down the in-process program.

9. The method as claimed in claim 8, further comprising the steps of:
determining whether there is any opened sub-window in the in-process program; and
shutting down all opened sub-windows when there is any opened sub-window.

10. The method as claimed in claim 8, further comprising the step of:
shutting down the in-process program when there is no pop-out dialog box.

11. The method as claimed in claim 8, further comprising the step of:
closing the pop-out dialog box when the pop-out dialog box is not a saving prompt.

12. The method as claimed in claim 8, further comprising the step of:
shutting down the electrically powered device when all in-process programs are shut down.

13. A method of safely shutdown an electrically powered device during an abnormal power-off, comprising steps of:
(1) selecting one of programs in process;
(2) shutting down sub-windows if said sub-windows are running, or sending out shutdown message to the program if no said sub-windows are running;
(3) saving the program if a dialog box is a saving prompt, or closing said dialog box is said dialog is not a saving prompt, or directly skipping to step (4) if no said dialog box exists;
(4) repeating steps (1)-(3); and
(5) shutting down the electrically powered device after all said programs shut down.
